(19) United States
(12) Patent Application Publication
(10) Pub. No.: US 2015/0248846 A1
(43) Pub. Date: Sep. 3, 2015

(54) CONSTRUCTION KIT FOR MODULE TYPE CIRCUIT ELEMENTS

(71) Applicants: Min Soo KANG, Busan (KR); Mi Hee PARK, Busan (KR)

(72) Inventors: Min Soo KANG, Busan (KR); Mi Hee PARK, Busan (KR)

(21) Appl. No.: 14/698,005

(22) Filed: Apr. 28, 2015

Related U.S. Application Data
(63) Continuation of application No. PCT/KR2013/007603, filed on Aug. 23, 2013.

(30) Foreign Application Priority Data
Oct. 29, 2012 (KR) 10-2012-0120317

(51) Int. Cl. G09B 23/18

(52) U.S. Cl. CPC G09B 23/185

(57) ABSTRACT

According to a construction kit for module type circuit elements disclosed in the present invention, individual circuit elements for forming an electronic circuit are formed in the shape of a module, a circuit diagram and the actual elements of the circuit elements can be intuitionally identified through an upper surface and a lower surface of a circuit element block module having the shape of module, user convenience is improved by coupling the circuit element block module with a lead line connection block module without using a soldering process or a wire connection process, a connection error and a malfunction of a port occurring in existing SMD or dip type circuit elements are prevented, and the learning of the electronic circuit elements can be improved by enhancing an intuitive learning approach of a learner.

### CROSS-REFERENCE TO RELATED APPLICATION(S)

This application is a continuation application, claiming the benefit under §365(c), of an international application serial number PCT/KR2013/007603, filed on Aug. 23, 2013, which claimed the benefit of a Korean patent application filed on Oct. 29, 2012 in the Korean Intellectual Property Office and assigned Serial number 10-2012-0120317, the entire disclosures of each of which is hereby incorporated by reference.

### TECHNICAL FIELD

The present invention generally relates to a construction kit of modular circuit elements and, more particularly, to a construction kit of modular circuit elements, in which individual circuit elements constituting an electronic circuit are implemented in the form of modules and in which respective circuit element block modules are electrically connected via lead wire connection block modules, thus constructing the electronic circuit that enables circuit experiments.

### BACKGROUND

As typical circuit parts for existing circuit construction, two types are used. That is, typical circuit parts are classified into dip-type elements and Surface-Mount Device (SMD)-type elements, wherein SMD-type elements are used for commercial purposes and are manufactured as a board via a Surface-Mount Technology (SMT) operation on a Printed Circuit Board (PCB). In contrast, dip-type elements are used for large-scale equipment or experiments.

Existing SMD-type elements are disadvantageous in that they are too small to be used for experiments in passive elements and Integrated Circuit (IC)-type elements. Dip-type elements are disadvantageous in that circuit construction is complicated when wires are connected and elements are inserted into a breadboard, and in that separate components such as solder or breadboard connectors are required for connection. For this reason, persons who investigate, or study and develop electronic circuits typically construct an electronic circuit using a socket, or construct an electronic circuit on a breadboard to thus conduct experiments.

Meanwhile, electronic circuit training kits may be used as training materials. Those training materials allow elementary, middle and high school students to understand electronic circuits via practical exercises. For such an electronic circuit training kit, several levels of products have been sold depending on the level of difficulty of electronic circuits. However, a single electronic circuit training kit is configured such that a circuit diagram, a simple specification, electronic elements (resistors, integrated circuits (ICs), condensers, diodes, etc.) and other components are enclosed. A learner inserts individual electronic elements and electronic parts into holes formed in a Printed Circuit Board (PCB), and solders them, thus completing the actual manufacturing of an electronic circuit.

However, when electronic elements are damaged due to overheating caused by inexperience in a soldering technique during a manufacturing process, or when a hole in a board is falsely determined and an electronic element is soldered in a hole at an inexact location, an electronic circuit is not normally operated. Most learners experience such non-functioning or malfunctioning of their constructed circuits. In particular, it is difficult to separate electronic elements and parts which are once fixed via soldering, and such electronic elements and parts may be additionally damaged due to re-heating in a separation procedure. Further, it is very difficult for persons who do not have expert knowledge of circuits to detect faults in individual elements on mutually connected electronic circuits.

### SUMMARY

The present invention has been made keeping in mind the above problems occurring in the prior art, and an object of the present invention is to provide an construction kit of modular circuit elements, in which individual circuit elements constituting an electronic circuit are implemented in the form of modules, and which may intuitively check a circuit diagram and an actual configuration of each circuit element via the upper surface and the lower surface of each circuit element block module implemented in the form of a module, and enable a circuit element block module and a lead wire connection block module to be coupled to each other without requiring a soldering or wiring procedure, thus improving a user's convenience, preventing a wiring error and malfunctioning in ports which occur in existing SMD-type or dip-type circuit elements, and allowing the learning of electronic circuit construction to be improved via the strengthening of intuitive access of a learner.

Another object of the present invention is to provide a construction kit of modular circuit elements, which allow even non-experts to construct a simple circuit using circuit element block modules and lead wire connection block modules, which are provided in the form of modules, without undergoing difficulty in wiring, thus enabling a complicated electronic circuit as well as a simple electronic circuit to be simply constructed, and allowing the constructed circuit to be intuitively checked.

A further object of the present invention is to provide a construction kit of modular circuit elements, in which, upon configuring a circuit element block module, a switch, a variable resistor, a Light Emitting Diode (LED), an electric bulb, and a speaker that correspond to an input unit and an output unit are configured to be exposed so that they can be actually operated, adjusted, and output in the circuit element block module, thus allowing the user to personally control the elements in a constructed electronic circuit, and in which, upon configuring a lead wire connection block module, a signal measurement contact part is configured to be exposed and magnet members are configured in the lead wire connection block module, thus allowing the user to detect signals in circuit experiments via measurement equipment in the constructed electronic circuit; enabling learning to be performed by attaching circuit element block modules to an iron plate using the magnet members; enabling conductive portions to be firmly coupled; improving scalability by integrating multiple 4-direction and 4-channel configurations; and reducing molding costs upon upgrading.

In order to accomplish the above objects, a construction kit of modular circuit elements according to features of the present invention is a construction kit of modular circuit elements, in which individual circuit elements constituting an electronic circuit are provided in a form of modules, each of circuit element block modules including a block-shaped module case in which semicircular recessed or semicircular protruding channels are formed on side surfaces of the module case corresponding to four directions, other than an upper surface and a lower surface; a circuit diagram of a circuit element indicated on any one of the upper surface and the lower surface of the module case; an actual circuit element which is installed to be mounted in the module case, and an image of which is indicated on the upper surface or the lower surface of the module case that is opposite to the surface on which the circuit diagram of the circuit element is indicated; and a circuit element contact part connected to a lead wire of the circuit element and exposed to enable an electrical connection through the semicircular recessed or semicircular protruding channels formed on the side surfaces of the module case.

Preferably, the module case may be made of any one material selected from the group consisting of non-conductive materials including a plastic material, a wood material, and a rubber material.

Preferably, the circuit element contact part may be exposed to enable an electrical connection through the semicircular recessed or semicircular protruding channels formed on the side surfaces of the module case, and may be formed in any one of a horizontal linear shape extending from the lead wire of the circuit element and a shape including a part of a semicircular recess or a semicircular protrusion of a corresponding channel.

The circuit element block module may be an electronic part including a resistor, a diode, a condenser, an Integrated Circuit (IC), a transistor, a coil, a switch, a variable resistor, a Light Emitting Diode (LED), an electric bulb, a display or a speaker.

Preferably, the circuit element block module implemented using the electronic part of the IC may be specialized for a single gate corresponding to any one of AND, NOT, OR, NAND, and NOR gates.

Preferably, each of the circuit element block modules implemented using electronic parts of the switch and the variable resistor may be configured to be exposed from any one of the upper surface and the lower surface of the module case so that the circuit element is operable.

Preferably, each of the circuit element block modules implemented using electronic parts including the LED, the electric bulb, the display, and the speaker may be configured to be exposed from any one of the upper surface and the lower surface of the module case so that a function of the circuit element depending on each characteristic thereof is operated and output.

Preferably, the construction kit may further include lead wire connection block modules coupled to the circuit element block modules on a module basis, upon constructing an electronic circuit of the circuit element block modules, thus assisting in an electrical connection.

Preferably, each of the lead wire connection block modules may include a block-shaped case coupled to the module case in a correspondence manner, and configured such that semicircular recessed or semicircular protruding channels are formed on side surfaces of the case corresponding to four directions; a connection line in which wiring including shapes of “┐, └, ⊥ [symbol] , ┤, ├, -, and |” is formed in the case; and a lead wire connection contact part configured to extend from the connection line and exposed to enable an electric connection through the semicircular recessed or semicircular protruding channels formed on the side surfaces of the case.

Preferably, the lead wire connection block module may further include a signal measurement contact part that is connected to the connection line so that signals are measured via measurement equipment including an oscilloscope in circuit experiments, and that is configured to be exposed from any one or both of upper and lower surfaces of the case, upon constructing an electronic circuit via a combination with the circuit element block modules.

Preferably, the lead wire connection block module may include one or more magnet members that are attached to a vertically standing iron plate and that enable an electrical connection between conductive portions of lead wire connection contact parts of the lead wire connection block modules to be firmly made, upon constructing an electronic circuit via a combination with the circuit element block modules.

Preferably, the construction kit may further include blank block modules for filling block spaces that remain as empty spaces in construction of an entire electronic circuit, upon constructing an electronic circuit via a combination of the circuit element block modules and the lead wire connection block modules.

Preferably, each of the blank block modules may be made of Styrofoam having a shape identical to that of the circuit element block modules and the lead wire connection block modules.

In accordance with the construction kit of modular circuit elements proposed in the present invention, individual circuit elements constituting an electronic circuit are implemented in the form of modules, a circuit diagram and an actual configuration of each circuit element may be intuitively checked via the upper surface and the lower surface of each circuit element block module implemented in the form of a module, and a circuit element block module and a lead wire connection block module may be coupled to each other without requiring a soldering or wiring procedure, thus improving a user's convenience, preventing a wiring error and malfunctioning in ports which occur in existing SMD-type or dip-type circuit elements, and allowing the learning of electronic circuit construction to be improved via the strengthening of intuitive access of a learner.

Further, in accordance with the present invention, even non-experts may construct a simple circuit using circuit element block modules and lead wire connection block modules, which are provided in the form of modules, without undergoing difficulty in wiring, thus enabling a complicated electronic circuit as well as a simple electronic circuit to be simply constructed, and allowing the constructed circuit to be intuitively checked.

Furthermore, the present invention is configured such that, upon configuring a circuit element block module, a switch, a variable resistor, a Light Emitting Diode (LED), an electric bulb, and a speaker that correspond to an input unit and an output unit are configured to be exposed so that they can be actually operated, adjusted, and output in the circuit element block module, thus allowing the user to personally control the elements in a constructed electronic circuit, and such that, upon configuring a lead wire connection block module, a signal measurement contact part is configured to be exposed and magnet members are configured in the lead wire connection block module, thus allowing the user to detect signals in circuit experiments via measurement equipment in the constructed electronic circuit; enabling learning to be performed by attaching circuit element block modules to an iron plate using the magnet members; enabling conductive portions to be firmly coupled; improving scalability by integrating multiple 4-direction and 4-channel configurations; and reducing molding costs upon upgrading.

### BRIEF DESCRIPTION OF DRAWINGS

FIG. 1 is a perspective view showing a construction kit of modular circuit elements according to an embodiment of the present invention;

FIG. 2 is a diagram showing coupling parts of a construction kit of modular circuit elements according to an embodiment of the present invention;

FIG. 3 is a diagram showing an example of actual configuration of circuit element block modules in the electronic circuit construction of the construction kit of modular circuit elements according to an embodiment of the present invention;

FIG. 4 is a diagram showing examples of the configuration of the signal measurement contact part of a lead wire connection block module in the electronic circuit construction of the construction kit of modular circuit elements according to an embodiment of the present invention;

FIG. 5 is a diagram showing the arrangement of magnet members of the lead wire connection block module of the construction kit of modular circuit elements according to an embodiment of the present invention;

FIG. 6 is a diagram showing the electronic circuit construction of the construction kit of modular circuit elements before empty spaces are filled with blank block modules according to an embodiment of the present invention;

FIG. 7 is a diagram showing the electronic circuit construction of the construction kit of modular circuit elements in which empty spaces are filled with blank block modules according to an embodiment of the present invention;

FIG. 8 is a diagram showing examples of the configuration of the construction kit of modular circuit elements according to an embodiment of the present invention;

FIG. 9 is a diagram showing examples in which multiple 4-direction and 4-channel cases are integrated to increase the number of channels in the construction kit of modular circuit elements according to an embodiment of the present invention; and

FIG. 10 is a diagram showing an example of a circuit element block module in which 4-direction and 4-channel cases are integrated to increase the number of channels to 8 channels in the construction kit of modular circuit elements according to an embodiment of the present invention.

Description of the Reference Numerals

100: circuit element block module 110: module case
111: channel 120: circuit diagram of circuit element
130: circuit element 140: circuit element contact part
200: lead wire connection block module 210: case
211: channel 220: connection line
230: lead wire connection contact part 240: signal measurement contact part
250: magnet member 300: blank block module

### DETAILED DESCRIPTION

Preferred embodiments of the present invention are described with reference to the accompanying drawings in order to describe the present invention in detail so that those having ordinary knowledge in the technical field to which the present invention pertains can easily practice the present invention. In the following detailed description of the preferred embodiments of the present invention, detailed descriptions of related known functions or configurations that are deemed to make the gist of the present invention obscure will be omitted. Further, it should be noted that the same reference numerals are used to designate elements for performing similar functions and operations throughout the drawings.

Throughout the entire specification, it should be understood that a representation indicating that a first component is “connected” to a second component may include the case where the first component is “indirectly connected” to the second component with some other component interposed therebetween, as well as the case where the first component is “directly connected” to the second component. Further, it should be understood that a representation such as “including” a certain component means that other components may be further included without excluding a possibility that other components will be added unless a description to the contrary is specifically pointed out in context.

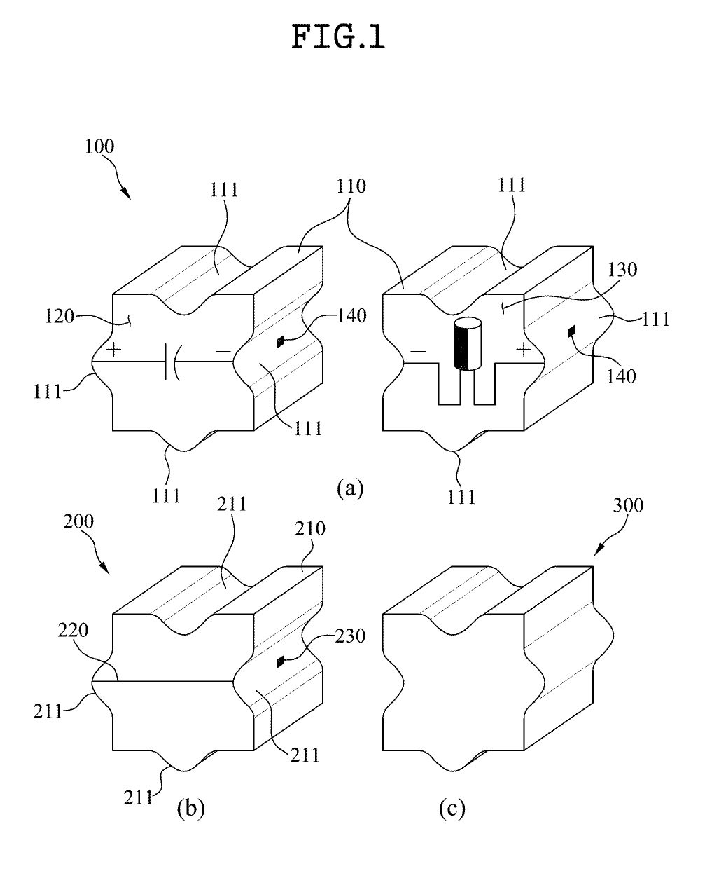

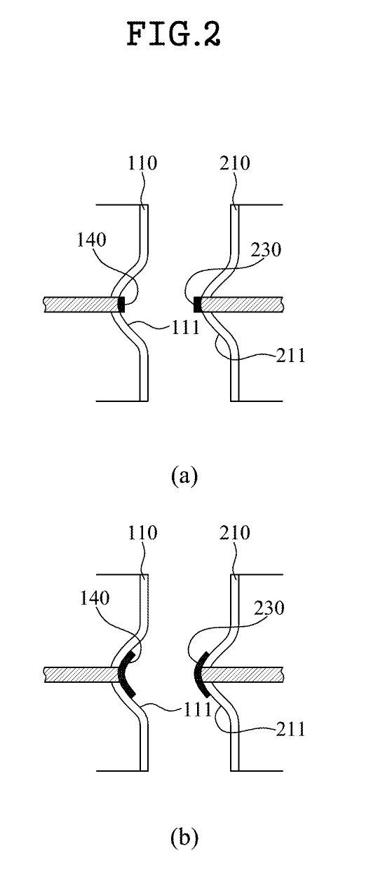

FIG. 1 is a perspective view showing a construction kit of modular circuit elements according to an embodiment of the present invention, and FIG. 2 is a diagram showing coupling parts of a construction kit of modular circuit elements according to an embodiment of the present invention. As shown in FIGS. 1 and 2, the construction kit of modular circuit elements according to an embodiment of the present invention may include a circuit element block module 100 and a lead wire connection block module 200, and may further include a blank block module 300.

The construction kit of modular circuit elements according to an embodiment of the present invention is a construction kit in which individual circuit elements constituting an electronic circuit are implemented in the form of modules. The construction kit of modular circuit elements according to the present invention is a modular construction kit for presenting a method capable of more simply constructing electronic circuits by overcoming disadvantages in that, in the case of an existing SMD-type, SMD-type elements are too small to be used for experiments in passive elements and IC-type elements and in that, in the case of an existing dip-type, the construction of circuits of dip-type elements is complicated when wires are connected and elements are inserted into a breadboard, and separate components such as solder or a breadboard connector are required for connection.

That is, the construction kit of modular circuit elements according to the embodiment of the present invention may present a type of module to which small ICs or resistors can be connected, without requiring a breadboard, and may be configured to have various sizes depending on the age of a user and the purpose of usage. For example, when the construction kit is used to instruct elementary school students in understanding logic gates, the construction kit may be manufactured and provided at a large size identical to that of the palm of the hand of a child depending on the usage purpose of the child to enable the configuration of gates. Further, when the construction kit is used to instruct college students or mechanical engineers in designing easy ICs, SMD-type elements may be manufactured and provided as small-sized structures having the same shape.

As shown in FIG. 1(a), the circuit element block module 100 includes a block-shaped module case 110 in which semicircular recessed or semicircular protruding channels 111 are formed on side surfaces of the module case 110 corresponding to four directions, except for an upper surface and a lower surface; a circuit diagram 120 of a circuit element indicated on any one of the upper surface and the lower surface of the module case 110; an actual circuit element 130 which is installed to be mounted in the module case 110 and an image of which is indicated on the upper or lower surface of the module case 110 that is opposite to the surface on which the circuit diagram 120 of the circuit element is indicated; and circuit element contact parts 140 which are connected to the lead wire of the circuit element 130 and which are exposed to enable an electrical connection through the semicircular recessed or semicircular protruding channels 111 formed on the side surfaces of the module case 110.

Here, the module case 110 may be made of any one material selected from the group consisting of non-conductive materials including a plastic material, a wood material, and a rubber material. Further, the circuit element contact parts 140 are exposed to enable an electrical connection through the semicircular recessed or semicircular protruding channels 111 formed on the side surfaces of the module case 110. The module case 110 may be configured using any one of a horizontal linear shape in which each circuit element contact part 140 extends from the lead wire of the circuit element 130, as shown in FIG. 2(a), and a shape in which the circuit element contact part 140 includes a part of the semicircular recess or semicircular protrusion of the channel 111, as shown in FIG. 2(b). In FIG. 2 according to the present invention, although the circuit element contact part 140 protrudes in an exaggerated fashion, it merely shows an example of description of the configuration thereof, and, in practice, the circuit element contact part 140 needs only to be exposed from the channel 111 of the module case 110 to such an extent that an electric connection is possible.

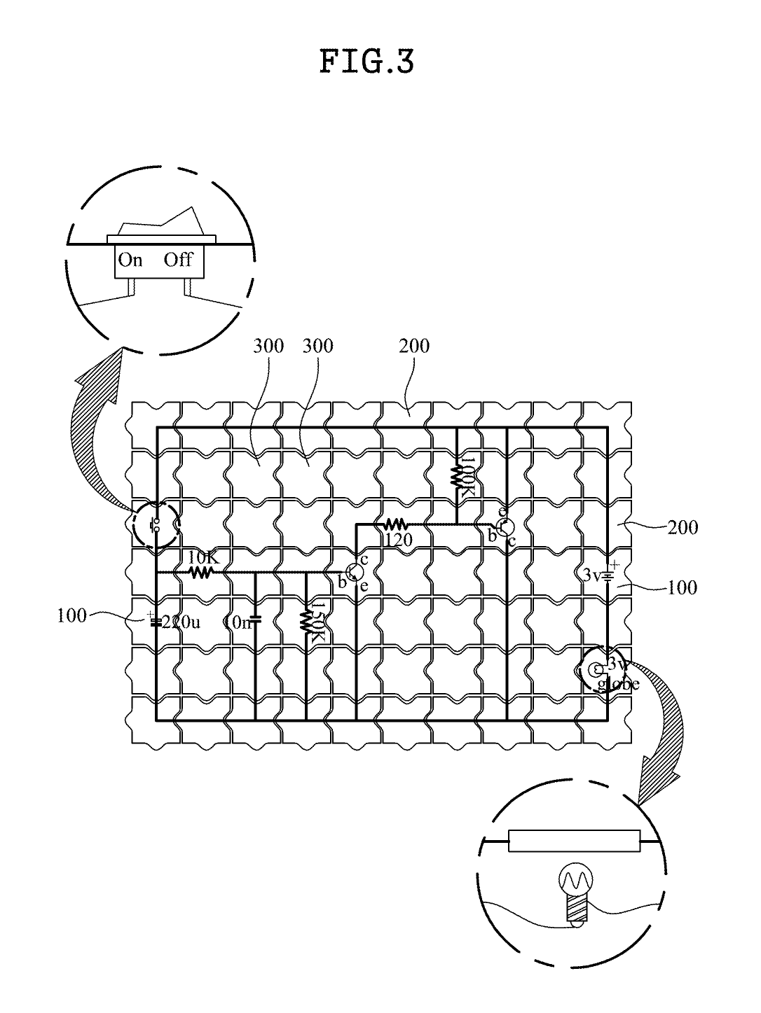

Further, circuit element block modules 100 may be configured using electronic parts including a resistor, a diode, a condenser, an IC, a transistor, a coil, a switch, a variable resistor, an LED, an electric bulb, a display, a speaker, etc. Here, a circuit element block module 100 configured using electronic parts of an IC may be specialized for a single gate, that is, one of AND, NOT, OR, NAND, and NOR gates. This shows that existing most gate elements are NAND and NOR gates, and these are specialized for a single gate element, so that only a single function may be more simply configured, more intuitive approach to learning or usage may be strengthened, and malfunction caused by wiring error in ports may be prevented. That is, in the case of typical logic gates and ICs, an actual IC is configured such that a large number of gates are complexly configured, thus making it convenient to construct a circuit. However, a problem in which, when it is desired to configure a single gate, it is difficult to understand circuits due to unnecessary input/output terminals may be solved. Further, as shown in FIG. 3, each circuit element block module 100 implemented using an electronic part, such as a switch or a variable resistor, may be configured to be exposed from any one of the upper and lower surfaces of the module case 110 so that the operation of the circuit element 130 is possible. Furthermore, as shown in FIG. 3, each circuit element block module 100 implemented using an electronic part, such as an LED, an electric bulb, a display or a speaker, may be configured to be exposed from any one of the upper and lower surfaces of the module case 110 so that the function of the circuit element 130 depending on each characteristic thereof is operated and output.

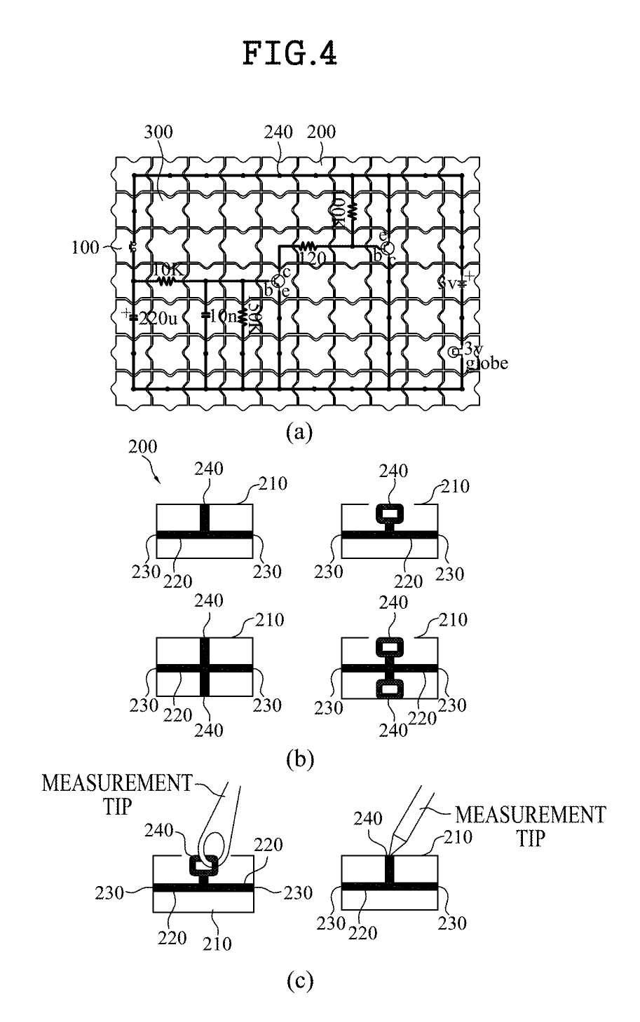

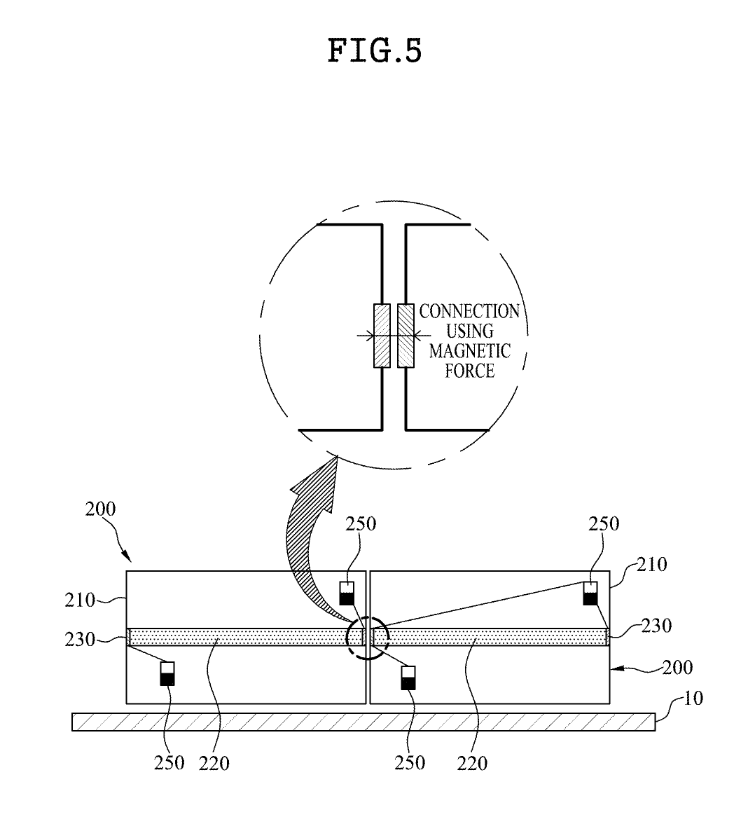

As shown in FIG. 1(b), the lead wire connection block module 200 is coupled to circuit element block modules 100 on a module basis upon constructing the electronic circuit of the circuit element block modules 100, thus assisting in an electric connection. Such a lead wire connection block module 200 includes a block-shaped case 210 which can be coupled to the module case 110 in a correspondence manner, and in which semicircular recessed or semicircular protruding channels 211 are formed on side surfaces of the case 210 corresponding to four directions; a connection line 220 in which wiring including shapes of “┐, └, ⊥ [symbol] , ┤, ├, -, and |” is formed in the case 210; and lead wire connection contact parts 230 which extend from the connection line 220 and which are exposed to enable an electrical connection through the semicircular recessed or semicircular protruding channels 211 formed on the side surfaces of the case 210. Here, as shown in FIG. 4, the lead wire connection block module 200 may further include a signal measurement contact part 240 that is connected to the connection line 220 so that signals may be measured via measurement equipment such as an oscilloscope in circuit experiments and that is configured to be exposed from any one or both of the upper and lower surfaces of the case 210, upon constructing an electronic circuit via a combination with the circuit element block modules 100. Further, as shown in FIG. 5, the lead wire connection block module 200 may include, in the case 210, one or more magnet members that are attached to a vertically standing iron plate 10 and that enable an electrical connection between conductive portions of the lead wire connection contact parts 230 of the lead wire connection block modules 200 to be stably made, upon constructing an electronic circuit via a combination with the circuit element block modules 100.

As shown in FIG. 1(c), a blank block module 300 is a component filling each block space that remains as an empty space in the entire electronic circuit, upon constructing the electronic circuit via a combination of circuit element block modules 100 and lead wire connection block modules 200. Such a blank block module 300 may be made of Styrofoam having the same shape as the circuit element block modules 100 and the lead wire connection block modules 200.

FIG. 2 is a diagram showing coupling portions of the construction kit of modular circuit elements according to an embodiment of the present invention. FIG. 2(a) illustrates a case where a circuit element contact part 140 and a lead wire connection contact part 230 are coupled to each other in a horizontal linear shape in coupling portions between a circuit element block module 100 and a lead wire connection block module 200, and FIG. 2 (b) illustrates the case of a shape in which the circuit element contact part 140 and the lead wire connection contact part 230 include parts of the semicircular recess and protrusion of the channels 111 and 211, respectively, in coupling portions between the circuit element block module 100 and the lead wire connection block module 200.

FIG. 3 is a diagram showing an example of actual configuration of a circuit element block module in the electronic circuit construction of the construction kit of modular circuit elements according to an embodiment of the present invention. As shown in FIG. 3, when the circuit element block module 100 is implemented as a structure of an input unit and an output unit, a switch configured as in an enlarged view in an upper portion of the drawing is operable in such a way that, on a front surface on which an image of an actual switch corresponding to a circuit diagram on a rear surface is indicated, an actual switch operating portion is provided to enable the operation of the switch. An LED or an electric bulb configured as in an enlarged view in a lower portion of the drawing is configured to emit light in such a way that a display device is implemented as a transparent structure. A sound output device such as a speaker or a buzzer may be configured to output sound through a pored window.

FIG. 4 is a diagram showing examples of the signal measurement contact part of a lead wire connection block module in the electronic circuit construction of the construction kit of modular circuit elements according to an embodiment of the present invention. As shown in FIG. 4, in the lead wire connection block module 200, a signal measurement contact part 240 is configured such that signals may be measured via measurement equipment such as an oscilloscope (not shown) in the electronic circuit configured as shown in FIG. 4(a). That is, the signal measurement contact part 240 may be formed which is connected to the connection line 220 of the lead wire connection block module 200 and which is configured to be exposed from any one or both of the upper and lower surfaces of the case 210. FIG. 4(b) illustrates various examples of the signal measurement contact part 240 configured in the lead wire connection block module 200, and FIG. 4(c) illustrates an example of a contact with a measurement tip for signal detection in measurement equipment such as an oscilloscope.

FIG. 5 is a diagram showing the arrangement of magnet members of the lead wire connection block module in the construction kit of modular circuit elements according to an embodiment of the present invention. As shown in FIG. 5, an example is shown in which lead wire connection block modules 200 are attached to a vertically standing iron plate 10, and in which one or more magnet members are configured in the case 210 to enable an electric connection between conductive portions of the lead wire connection contact parts 230 of the lead wire connection block modules 200 to be firmly made, upon constructing an electronic circuit via a combination with circuit element block modules 100. Here, the magnet members 250 are attached to the iron plate 10 to function not only to fix a circuit diagram and a circuit, but also to solve the problem of conductive connection portions being loosed and to facilitate the connection by using a magnetic force. That is, the configuration of the circuit diagram 120 of each circuit element on the upper surface of the circuit element block module 100 and the configuration of the actual circuit element 130 on the lower surface thereof are attached to the iron plate 10 to be checked and are not easily moved, thus enabling the circuit element block module to be attached to a wall surface and to be utilized for education.

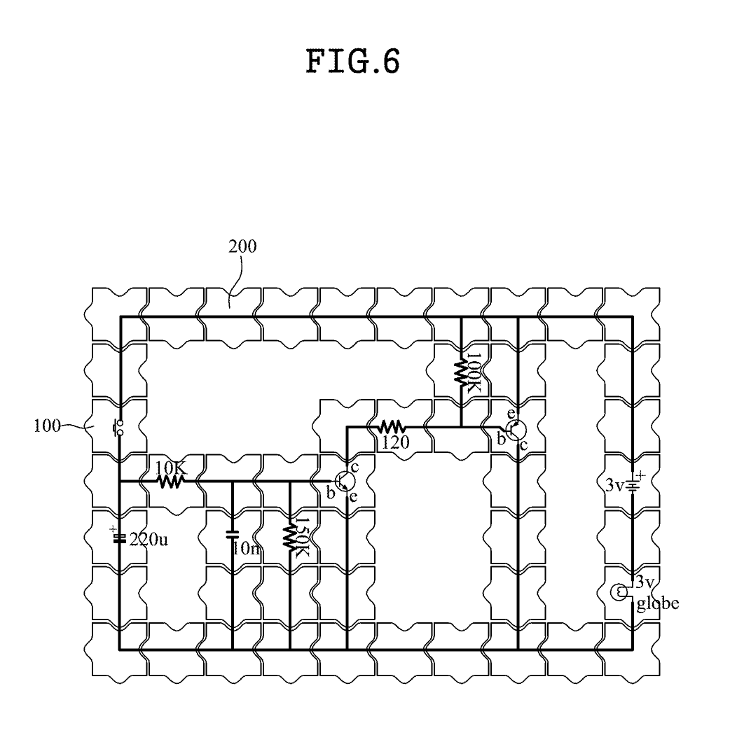

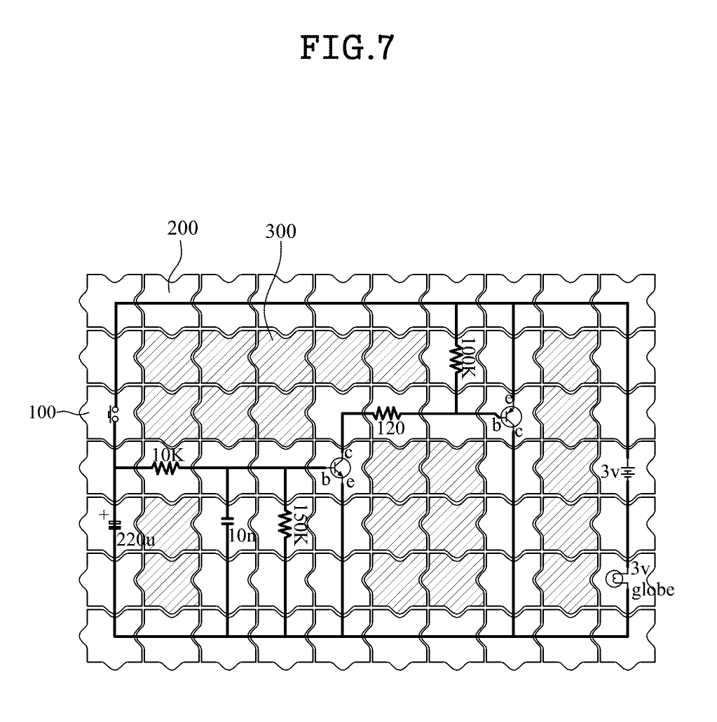

FIG. 6 is a diagram showing the electronic circuit construction of the construction kit of modular circuit elements before empty spaces are filled with blank block modules according to an embodiment of the present invention, and FIG. 7 is a diagram showing the electronic circuit construction of the construction kit of modular circuit elements in which blank block modules fill empty spaces according to an embodiment of the present invention. FIG. 6 illustrates a state in which an electronic circuit is constructed using circuit element block modules 100 and lead wire connection block modules 200 according to the present invention, and which is present before the block spaces that remain as empty spaces in connection of the electronic circuit are filled with blank block modules 300. FIG. 7 illustrates a state in which an electronic circuit is configured using circuit element block modules 100 and lead wire connection block modules 200 according to the present invention and in which block spaces that remain as empty spaces in the connection of the electronic circuit are filled with blank block modules 300. That is, the blank block modules 300 are auxiliary block components for solving a problem in which empty spaces occur in the electronic circuit to deteriorate appearance when a connection is made in an electronic circuit diagram, and in which mechanical rigidity cannot be maintained even when the block modules are inverted and actual elements are compared with circuit diagrams.

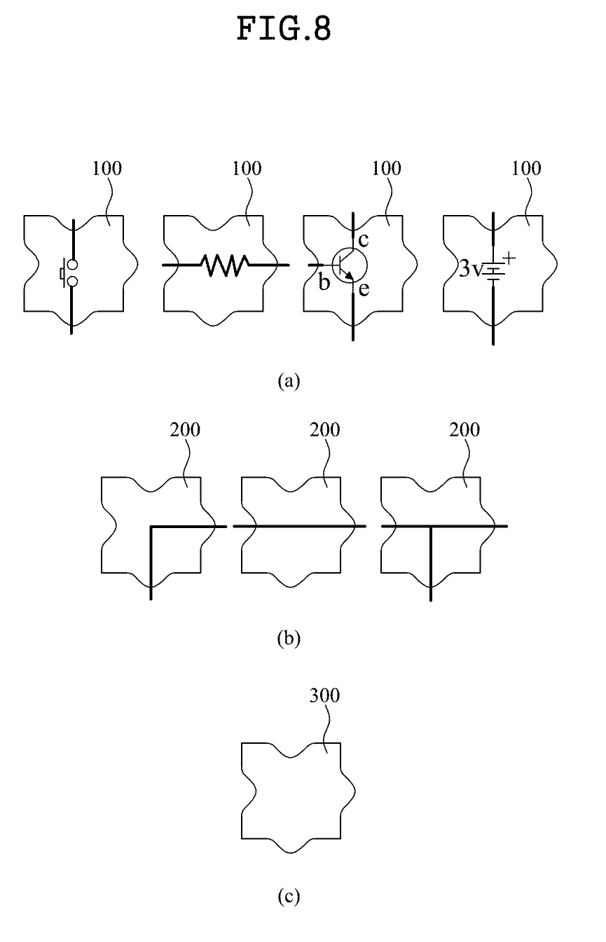

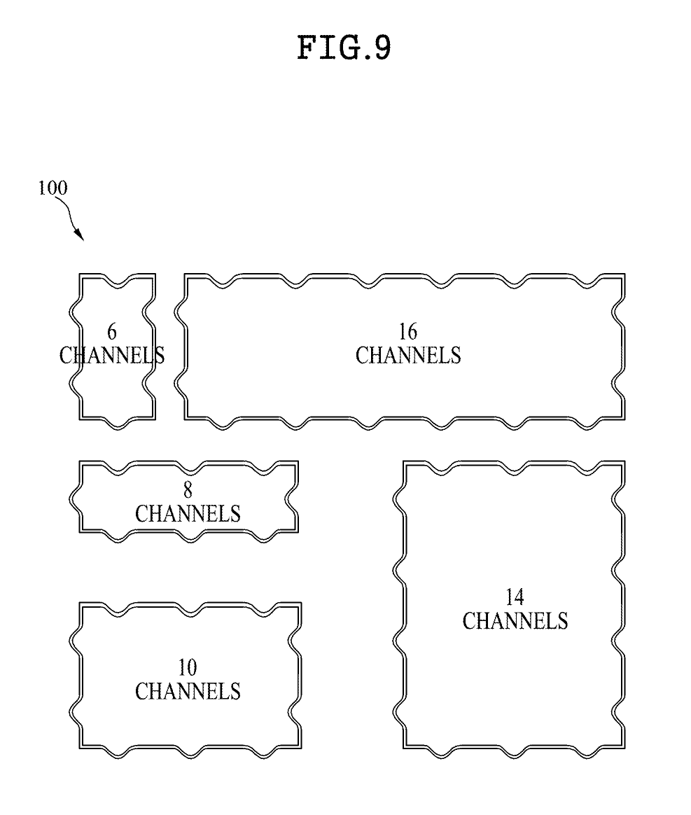

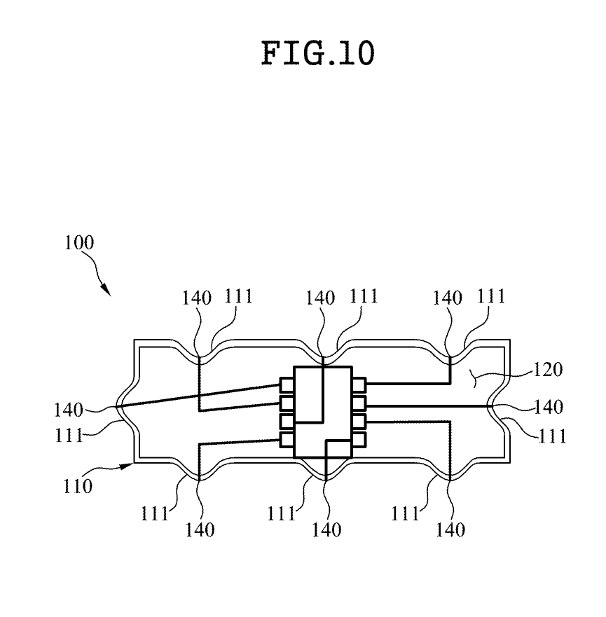

FIG. 8 is a diagram showing configuration examples of the construction kit of modular circuit elements according to an embodiment of the present invention, and FIG. 9 is a diagram showing an example in which multiple 4-direction and 4-channel cases are integrated to increase the number of channels in the construction kit of modular circuit elements according to an embodiment of the present invention, and FIG. 10 a diagram showing an example of a circuit element block module in which 4-direction and 4-channel cases are integrated to increase the number of channels to 8 channels in the construction kit of modular circuit elements according to an embodiment of the present invention. That is, FIG. 8(a) illustrates various examples of the circuit element block module 100, and shows a switch, a resistor, a transistor, and a power source (battery), and FIG. 8 (b) illustrates various examples of the connection line 220 of the lead wire connection block module 200, and FIG. 8(c) illustrates the blank block module 300. FIG. 9 illustrates an example in which multiple circuit element block modules 100, each basically having a 4-direction and 4-channel module case 110, are integrated to increase the number of channels, and shows 6 channels, 8 channels, 10 channels, 14 channels, and 16 channels. That is, the circuit element block modules 100 according to the present invention may be configured to have various sizes by increasing the number of channels while connection lines and circuit parts are configured in the same structure based on the coupling portions of channels. This enables a structure in which cases basically having a 4-channel base form are connected to each other to be configured, thus reducing molding costs and enabling existing parts to be continuously used upon upgrading device modules in the future. FIG. 10 illustrates an example of a circuit element block module 100 extending to an 8-channel structure, which shows an example of the configuration of an IC.

As described above, the construction kit of modular circuit elements according to embodiments of the present invention allows young children, who do not understand electronic circuits or adults who are unfamiliar with electronic circuits due to low professionalism, to desirably understand circuits and to manufacture electronic circuits, via intuitive observation of a circuit element diagram and a circuit element respectively configured on the upper and lower surfaces of the module case of the circuit element block module. In particular, in the past, a user experienced a lot of difficulty such as the problem of circuit construction error and polarity connection and low learning effects because it was difficult for the user to intuitively understand polarities and substances in the configuration of a circuit diagram and actual configuration. In contrast, the present invention may solve the conventional problems and may not require a circuit construction process such as soldering or wiring, thus improving the user's convenience.

The above-described present invention may be modified or applied in various manners by those skilled in the art to which the present invention pertains, and the technical scope of the present invention should be defined by the accompanying claims.

What is claimed is:

1. An improved construction kit of modular circuit elements, in which individual circuit elements constituting an electronic circuit are provided in a form of modules, comprising:
each of circuit element block modules (100), comprising: a block-shaped module case (110) in which semicircular recessed or semicircular protruding channels (111) are formed on side surfaces of the module case corresponding to four directions, other than an upper surface and a lower surface; a circuit diagram (120) of a circuit element indicated on any one of the upper surface and the lower surface of the module case (110); an actual circuit element (130) which is installed to be mounted in the module case (110), and an image of which is indicated on the upper surface or the lower surface of the module case (110) that is opposite to the surface on which the circuit diagram (120) of the circuit element is indicated; and a circuit element contact part (140) connected to a lead wire of the circuit element (130) and exposed to enable an electrical connection through the semicircular recessed or semicircular protruding channels (111) formed on the side surfaces of the module case (110);
lead wire connection block modules (200), respectively, coupled to each of the circuit element block modules (100) on a module basis, upon constructing an electronic circuit of each of the circuit element block modules (100), thus assisting in an electrical connection; and
blank block modules (300) for filling block spaces that remain as empty spaces in construction of an entire electronic circuit, upon constructing an electronic circuit via a combination of each of the circuit element block modules (100) and each of the lead wire connection block modules (200),
wherein each of the lead wire connection block modules (200) comprises:
a block-shaped case (210) coupled to the module case (110) in a correspondence manner, and configured such that semicircular recessed or semicircular protruding channels (211) are formed on side surfaces of the case (210) corresponding to four directions;
a connection line (220) in which wiring including shapes of “┐, └, ⊥ [symbol] , ┤, ├, -, and |” is formed in the case (210); and
a lead wire connection contact part (230) configured to extend from the connection line (220) and exposed to enable an electric connection through the semicircular recessed or semicircular protruding channels (211) formed on the side surfaces of the case (210),
wherein each of the blank block modules (300) is made of Styrofoam having a shape identical to that of each of the circuit element block modules (100) and each of the lead wire connection block modules (200).

2. The improved construction kit of claim 1, wherein the module case (110) is made of any one material selected from the group consisting of non-conductive materials including a plastic material, a wood material, and a rubber material.

3. The improved construction kit of claim 1, wherein the circuit element contact part (140) is exposed to enable an electrical connection through the semicircular recessed or semicircular protruding channels (111) formed on the side surfaces of the module case (110), and is formed in any one of a horizontal linear shape extending from the lead wire of the circuit element (130) and a shape including a part of a semicircular recess or a semicircular protrusion of a corresponding channel (111).

4. The improved construction kit of claim 1, wherein the circuit element block module (100) is an electronic part including a resistor, a diode, a condenser, an Integrated Circuit (IC), a transistor, a coil, a switch, a variable resistor, a Light Emitting Diode (LED), an electric bulb, a display or a speaker.

5. The improved construction kit of claim 4, wherein the circuit element block module (100) implemented using the electronic part of the IC is specialized for a single gate corresponding to any one of AND, NOT, OR, NAND, and NOR gates.

6. The improved construction kit of claim 4, wherein each of the circuit element block modules (100) implemented using electronic parts of the switch and the variable resistor is configured to be exposed from any one of the upper surface and the lower surface of the module case (110) so that the circuit element (130) is operable.

7. The improved construction kit of claim 4, wherein each of the circuit element block modules (100) implemented using electronic parts including the LED, the electric bulb, the display, and the speaker is configured to be exposed from any one of the upper surface and the lower surface of the module case (110) so that a function of the circuit element (130) depending on each characteristic thereof is operated and output.

8. The improved construction kit of claim 4, wherein the lead wire connection block module (200) further comprises a signal measurement contact part (240) that is connected to the connection line (220) so that signals are measured via measurement equipment including an oscilloscope in circuit experiments, and that is configured to be exposed from any one or both of upper and lower surfaces of the case (210), upon constructing an electronic circuit via a combination with the circuit element block modules (100).

9. The improved construction kit of claim 4, wherein the lead wire connection block module (200) comprises one or more magnet members that are attached to a vertically standing iron plate (10) and that enable an electrical connection between conductive portions of lead wire connection contact parts (230) of the lead wire connection block modules (200) to be firmly made, upon constructing an electronic circuit via a combination with the circuit element block modules (100).
